(19) United States
(12) Patent Application Publication
(10) Pub. No.: US 2013/0282592 A1
(43) Pub. Date: Oct. 24, 2013

(54) System, Method and Computer Program Product for Registering Products and Promoting Customer Relationships

(71) Applicant: ELECTROLUX HOME PRODUCTS, INC., Charlotte, NC (US)

(72) Inventors: Robert Erik Zambrana, Charlotte, NC (US); Deonn Crumley Baker, Huntersville, NC (US); James Steven Evans, Winterville, NC (US)

(73) Assignee: Electrolux Home Products, Inc., Charlotte, NC (US)

(21) Appl. No.: 13/869,527

(22) Filed: Apr. 24, 2013

Related U.S. Application Data
(60) Provisional application No. 61/637,536, filed on Apr. 24, 2012.

(51) Int. Cl. G06Q 30/00

(52) U.S. Cl. CPC G06Q 30/012
USPC 705/302

(57) ABSTRACT

Regarding a product that is provided by a provider and received by a recipient, registration of the product and following-up with the recipient may be facilitated by way of web-based, symbology-driven product registration systems and methods.

### CROSS-REFERENCE TO RELATED APPLICATION

This application claims the benefit of U.S. Provisional Application No. 61/637,536, filed Apr. 24, 2012. The entire disclosure of U.S. Provisional Application No. 61/637,536, filed Apr. 24, 2012, is incorporated herein by reference.

### BACKGROUND

It is typical for companies to have Customer Relationship Management (“CRM”) systems for use in fostering relationships with customers. CRM systems typically comprise a computer database in which customer information is associated with product registration information. For example, when a customer purchases a product, the product may be accompanied by a product registration card that the customer may fill out, so that the completed product registration card includes information about both the customer and the product. Then, the customer may mail the completed registration card to the company or its agent, and the information from the card may be entered into the CRM computer database for future use by the company. For example, the CRM computer database may be used for handling product recalls and/or for soliciting extended service warranty business.

There are barriers in current product registration processes. For example, product registrations cards may need to be printed in different languages. Also, customers frequently do not complete and return product registration cards.

### SUMMARY

One aspect of this disclosure is the provision of web-based, symbology-driven product registration systems and methods.

In accordance with one aspect of this disclosure, a method for registering a product, which is provided by a provider (e.g., company) and received by a recipient (e.g., consumer), comprises associating at least one symbology with the product, wherein the at least one symbology comprises a decodable URL for at least indirectly accessing a website comprising a webpage, and the at least one symbology is configured to be imaged and decoded at least by a mobile device associated with the recipient. Associated with the URL is at least one product identifier of a plurality of different product identifiers. The method may further comprise associating the product identifier with information from the provider about the product in at least one computer database, wherein at least some of the information about the product varies between products. The method may further comprise a portal apparatus receiving the URL from a web browser of a recipient's mobile device. The method may further comprise the portal apparatus sending the webpage to the web browser of the recipient's mobile device at least in response to receiving the URL from the web browser of the recipient's mobile device, wherein the webpage includes fields for receiving personal information from the recipient for registering the product identified by the decodable product identifier. The method may further comprise the portal apparatus receiving the recipient's personal information from the web browser of the recipient's mobile device, at least partially in response to sending the webpage. The method may further comprise the portal apparatus associating the recipient's personal information with the information from the provider about the product identified by the decodable product identifier, for product registration purposes.

Thereafter, the provider may follow up with the recipient, comprising using at least some of the associated personal and product information for communicating with the recipient. Also, for each recipient, a unique relationship account may be established and associated with all of the recipient's registered products, such as for enhancing the relationship between the provider and the recipient. In this regard, subsequent receipt of the above-discussed URL from the recipient may result in another webpage being provided to the recipient, wherein the another webpage has associated therewith information about and/or tailored to one or more of (e.g., all of) the recipient's registered products.

The foregoing presents a simplified summary in order to provide a basic understanding of some aspects of this disclosure. This summary is not an extensive overview and is not intended to identify key or critical elements of the invention or to delineate the scope of the invention. The purpose of this section is to present some concepts of the disclosure in a simplified form as a prelude to the more detailed description that is presented later. Other aspects of this disclosure will become apparent from the following

### BRIEF DESCRIPTION OF THE DRAWINGS

Having described some aspects of this disclosure in general terms, reference will now be made to the accompanying drawings, which are not necessarily drawn to scale. The drawings are exemplary only, and should not be construed as limiting the invention.

FIG. 1 schematically illustrates aspects of systems and methods for registering products, in accordance with a first embodiment of this disclosure.

FIG. 2 is a more detailed view of a representative matrix code symbology schematically shown in FIG. 1.

FIG. 3 illustrates a Product Registration Webpage in accordance with the first embodiment.

FIGS. 4-7 schematically illustrate aspects of an exemplary method and associated features, in accordance with first and second embodiments of this disclosure.

FIG. 8 is a process flow diagram illustrating an exemplary overall process associated with at least registering a product that is provided by a provider and received by a recipient, in accordance with an aspect of this disclosure.

FIG. 9 is a process flow diagram illustrating an exemplary process that may be performed by a portal apparatus, for receiving communications from recipients and promoting relationships with recipients, in accordance with an aspect of this disclosure.

FIG. 10 illustrates a Relationship Webpage in accordance with an exemplary embodiment of this disclosure.

FIG. 11 illustrates a block diagram of, for example, a portal apparatus that may be implemented on one or more devices of this disclosure, and that may be operative for at least partially providing some of the features of this disclosure.

### DETAILED DESCRIPTION

Exemplary embodiments of this disclosure are described below and illustrated in the accompanying figures, in which like numerals refer to like parts. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

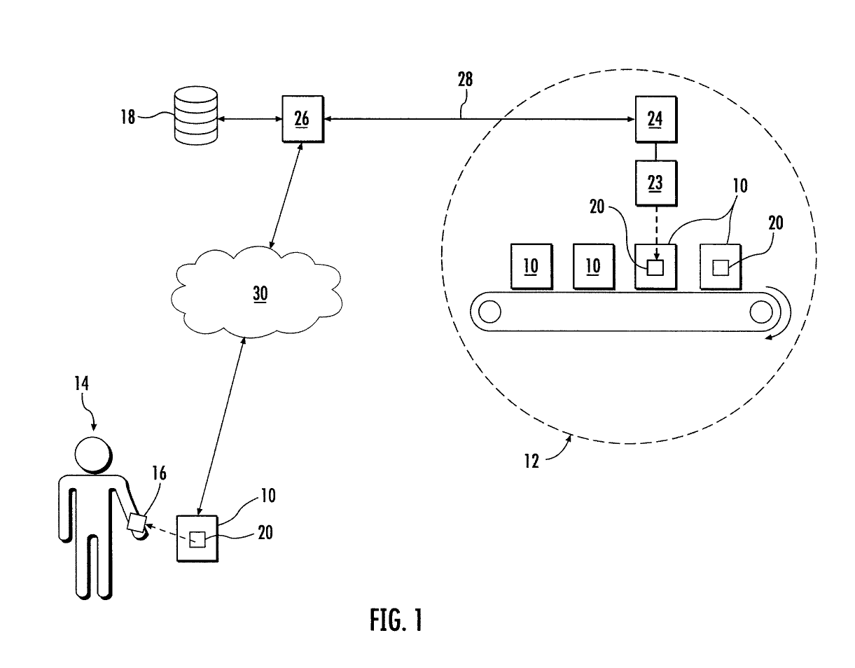

Referring in greater detail to the drawings, FIG. 1 schematically illustrates aspects of systems and methods for registering products 10, in accordance with a first embodiment of this disclosure. The products 10 may be provided by a provider, and the provider may be a company having a facility 12 (e.g., a manufacturing facility (e.g., factory), packaging facility, distribution facility and/or any other suitable type of facility) from which the products originate and/or through which the products pass. For example and not for the purpose of limiting the scope of this disclosure, in FIG. 1 a series of the products 10 at the facility 12 is schematically shown as traveling along an assembly line, conveyor system, or the like; whereas another product 10 is proximate a recipient 14 (e.g., customer). In FIG. 1, both the recipient 14 and the product 10 proximate the recipient are located remotely from the facility 12. The products 10 may be any suitable products, such as major appliances for air care, dish care, fabric care, food preparation, and food preservation; professional products; and small domestic appliances. As more specific examples, the products 10 may be appliances, such as kitchen and/or laundry appliances, although other types of products are also within the scope of this disclosure. The kitchen appliances may be one or more of an oven, stove, range, warmer, toaster, dishwasher, refrigerator, freezer, coffee maker, blender and crock pot. The laundry appliances may be one or more of a laundry washer, laundry dryer and iron. Other types of appliances such as, but not limited to, vacuum cleaners are also within the scope of this disclosure.

In one aspect, the first embodiment pertains to optimizing and streamlining the product registration process, such as by providing the ability for recipients 14 (e.g., customers) to register products 10 via a website and computerized mobile devices 16, such as smart phones. In addition, the utilization of codes imbedded in symbologies 20 and a computer database 18 comprising a look-up table, or the like, minimizes manual data entry in a manner that saves time and promotes accuracy, as will be discussed in greater detail below. The database 18 is shown in FIG. 1 as being associated with a computer and/or computer server 26, or the like, located remotely from the facility 12, although the database 18 may be located at the facility and be associated with a computer 24 at the facility, or the database 18 may be in any other suitable location(s).

The computer 24 and server 26 may be in communication with one another over a first network 28 and/or a second network 30, and/or the computer 24 and server 26 may be consolidated together into one or more computers. The first network 28 may be a dedicated network that is separate from the second network 30, or the first and second networks 28, 30 may be the same network. The first and second networks 28, 30 may include one or more suitable communication networks, such as, but not limited to, the Internet, cable television networks, cellular data networks, and/or the public switched telephone network. Alternatively, the server 26 together with the computer databases 18 may, optionally, be located at the facility 12 proximate the computer 24, in which case the server 26 and the computer 24 may be connected to one another by way of a local area network.

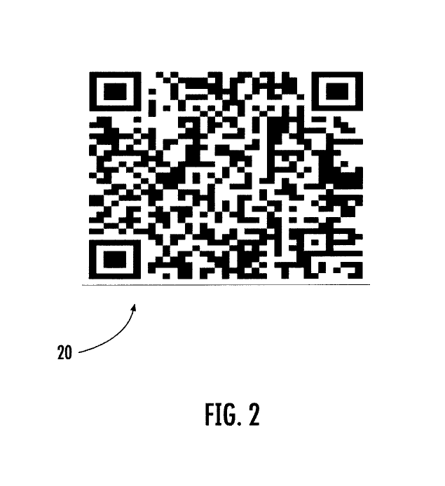

Codes used in the registration process may be embedded in suitable one-dimensional symbologies, such as Universal Product Code barcodes. However, two-dimensional symbologies 20, such as matrix codes having square or dot-shaped modules arranged on a grid pattern, or the like, may be preferred. Of particular interest may be the Quick Response (“QR”) type of matrix symbologies. An example of a suitable two-dimensional symbology 20 in the form of a matrix code symbology is shown in FIG. 2. The registration-related symbologies 20 may be printed by way of a printer 23 simultaneously with other symbologies that are conventionally associated with products 10.

More specifically regarding the codes embedded in the symbologies 22 for at least the registration process, these codes may optionally comprise both a product identifier and a universal resource locator (URL) (e.g., a shortened URL), or the codes embedded in the symbologies may consist essentially of, or consist of, URLs (e.g., shortened or short URLs) that function at least indirectly as, or are otherwise associated with, product identifiers. More specifically, each product 10 is identified by a unique identifier for product registration purposes (“product identifier”) (e.g., typically no two products have the same product identifier). For example, the product identifier may be a serial number for a product 10, although the product identifier is shorter than a typical product serial number.

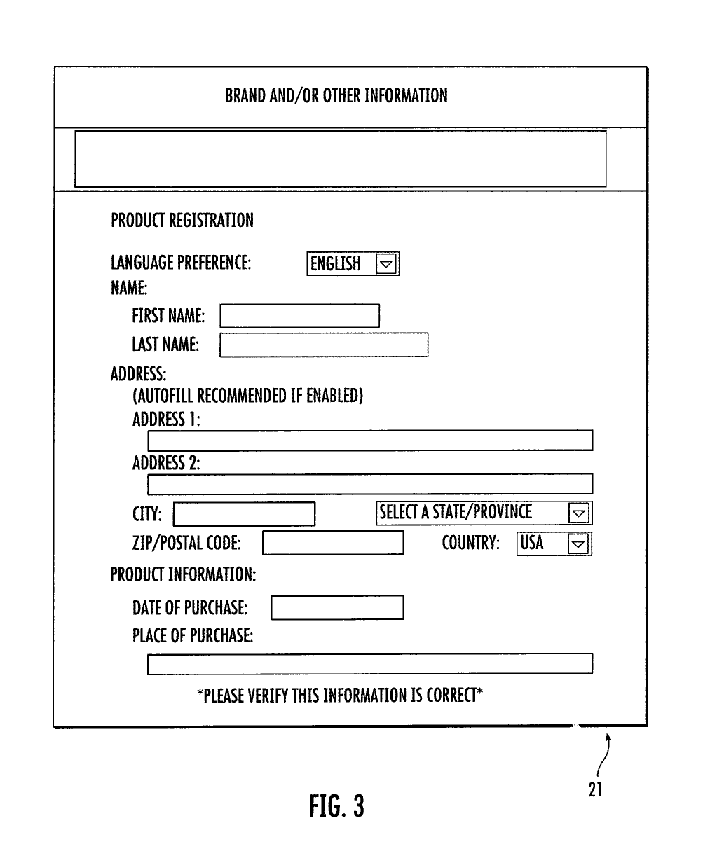

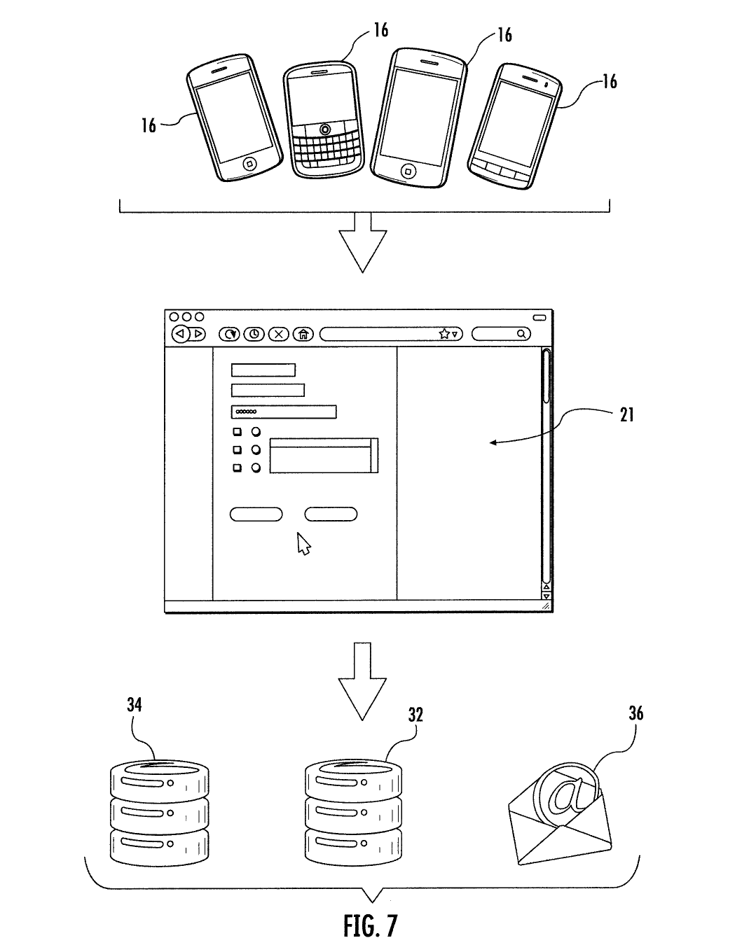

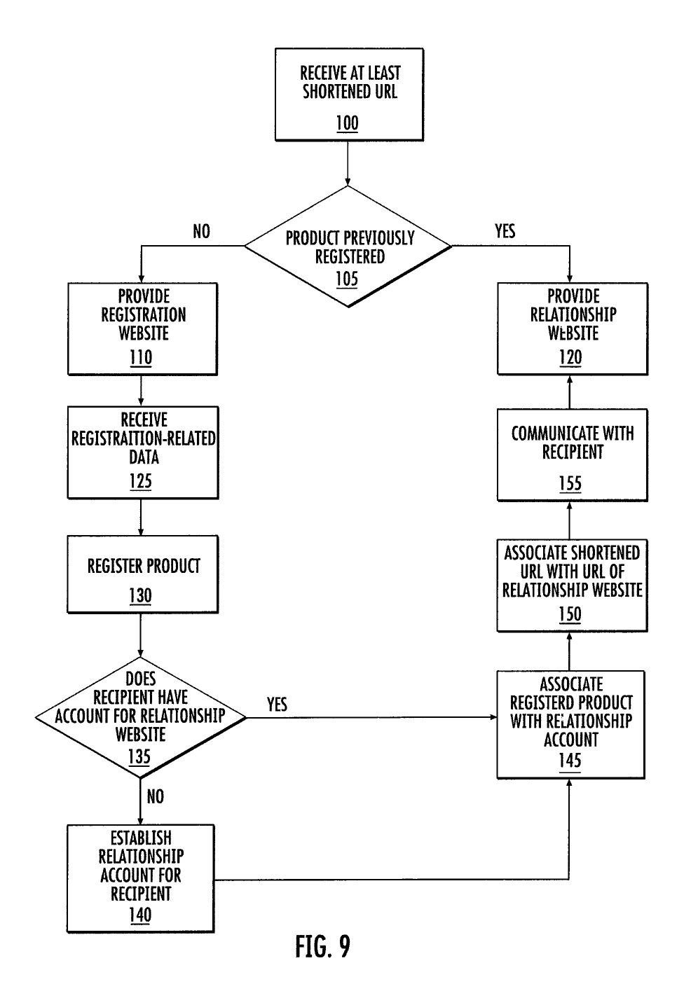

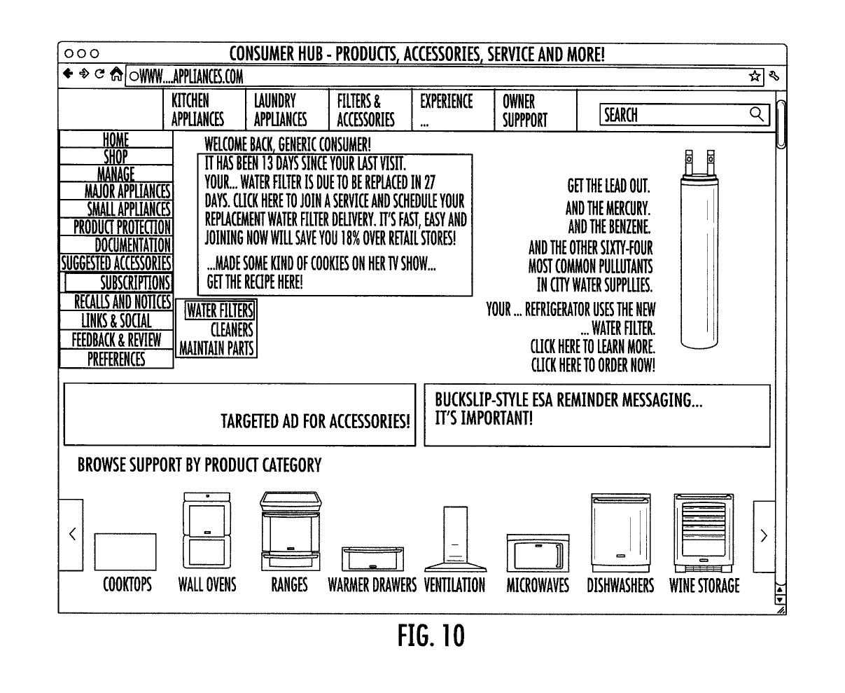

As mentioned above and as will be discussed in greater detail below, in some embodiments or versions of this disclosure, each symbology 20 may be decoded to provide only a short URL represent. However, this disclosure is not limited to such embodiments or versions. For example, in a first version of the first embodiment, for each product 10, the respective symbology 20 may include a URL (e.g., a shortened URL) and the respective product identifier. That is, the URL and respective product identifier are coded and embedded into each symbology 20. The URL is for at least indirectly accessing a portal apparatus comprising a module that is in the form of and/or for providing a Product Registration Website (e.g., a Product Registration Webpage 21 (FIGS. 3 and 7) of the Product Registration Website). Optionally, the URL may alternatively or also be for at least indirectly accessing a module that is in the form of and/or for providing a Relationship Website (e.g., a Relationship Webpage (FIG. 10) of the Relationship Website), as will be discussed in greater detail below with reference to FIG. 9. The portal apparatus may be, may consist essentially of, or may comprise the server 26, the computer 24, and/or any combination of these or other suitable features, such that the Product Registration and Relationship Websites may be hosted by the server 26, the computer 24, and/or by any other suitable features.

In the first version of the first embodiment, the same URL may be encoded into each of the symbologies 20, whereas each symbology has a different/unique product identifier encoded thereinto. In this first version, the product identifiers may be used to respectively identify the registration records of the database 18, wherein each registration record typically contains numerous fields for data.

In a second version of the first embodiment, each symbology 20 may “hold” (e.g., be decodable to provide) only a respective short URL, wherein each product 10 may be identified by a respective unique short URL (e.g., typically no two products have associated therewith the same short URL). In this second version, the short URLs may be used to respectively identify the registration records of the database 18, wherein each registration record typically contains numerous fields for data, such that each short URL may be respectively associated with a product by way of the product's serial number, product identifier and/or any other suitable identifiers, as will be discussed in greater detail below. For example, the unique short URLs may serve as the unique product identifiers.

In the first embodiment, software module(s) executing on the computer 24 located at the facility 12 (or any other suitable location) are operative for creating at least the short URLs, optionally also the product identifiers, and the symbologies 20, and these executing software modules are operative for associating the short URLs and optionally the product identifiers with some of the product registration information (e.g., product serial and model numbers); the symbologies are printed by the printer 23 located at the facility; and the symbologies 20 are respectively associated with products 10 and associated user manuals at the facility 12, all prior to the recipient 14 participating in the registration process. As one example, the symbologies 20 may be respectively printed onto adhesive-backed labels that are respectively stuck onto the products 10 at the facility 12, all prior to the recipient 14 participating in the registration process. Accordingly, in FIGS. 1, 2, 5 and 6, each feature identified by reference number 20 may be characterized as being illustrative of an adhesive-backed label that includes a symbology printed thereon, although any other suitable methods and features may be used for associating the symbologies, or the like, with the respective products 10. Typically, for each product 10, its associated, unique symbology may also be included in the user manual for the product.

The above-discussed software module(s) executing on the computer 24 may be incorporated into the existing batch process (e.g., fed by an Excel brand spreadsheet) scripted into Loftware brand enterprise label and print management software module(s), although any other suitable feature(s) (e.g., software module(s)) may be utilized. In addition, the script may go through a series of “GET/POST” parameters and/or a URL shortening script. The symbologies 20 may be respectively associated with the products by being mounted to the products, mounted to the packaging of the products, included on registration cards associated with the products (e.g., the symbologies may be placed on multilingual product registration cards) and/or the symbologies may be associated with the products in any other suitable manner

At least a portion of one or more of the features, aspects or steps described as being located at or carried out at the facility 12 may be located at or carried out in any other suitable location. For example, the symbologies 20 may be associated with the products 10 at any suitable location, such as locations positioned downstream from the factory in the flow of goods from the factory. As another example, at least some of the operations carried out by the computer 24 may be carried out by the server 26, and vice versa; and the computer 24 and server 26 may operate together to facilitate some aspects of this disclosure. For example, when the database 18 is associated with the server 26 as shown in FIG. 1, the computer 24 transmits data (e.g., database registration records) associating short URLs and/or product identifiers with product registration information (e.g., product serial and model number) to the server for populating or at least updating the look-up table feature, or the like, of the database 18. In the look-up table feature, or the like, of the database 18, product identifiers and/or short URLs may be associated with any other suitable information (e.g., for facilitating product registration, servicing, marketing, or the like) for the respective product 10, prior to the recipient 14 participating in the registration process. For example, the database 18 may comprise a Customer Relationship Management (“CRM”) computer database, and the look-up table may be in combination with, incorporated into and/or characterized as the CRM computer database (e.g., the look-up table may be integrated directly into the CRM computer database).

The registration records in the database 18 (e.g., the look-up table and/or CRM data) may be updated with short URLs and/or product identifiers and associated product registration information (e.g., product serial and model number) in real time with the creation of the product identifies and symbologies 20, or the updating may occur periodically in a batch process, typically prior to the recipient 14 participating in the registration process. For example, the model, serial numbers and product identifiers (e.g., short URLs) may be contained in the database 18 (e.g., CRM computer database) upon shipment of the associated products 10 from the factory 12, wherein the model and serial numbers are respectively associated with the corresponding product identifiers for later pairing with other information, as discussed in greater detail below. That is, the registration records contained in the computer database 18 and/or any other suitable location typically contain the model and serial numbers respectively associated with short URLs and/or any other suitable product identifiers for facilitating the registration process discussed in greater detail below. The provider (e.g., company or any other suitable provider) may further populate the registration records in the database 18 with any other pertinent information at any suitable point during the provider's manufacturing or later processes, such as at any suitable time before and/or after the recipient 14 participates in the registration process.

A recipient 14 of a product 10 may use a computerized mobile device 16 having an optical feature (e.g., module) to capture an image of the registration-related symbology 20 associated with the product 10 they have purchased or otherwise obtained. The optical feature capturing the image of the symbology may comprise a camera module or other suitable optical device module of the recipient's computerized mobile device 16 (e.g., smart phone/cell phone). The mobile device 16 may decode the captured image of the symbology 20 in a conventional manner, such as through execution of suitable software module(s). In accordance with one aspect of this disclosure, the information decoded from the symbology 20 comprises the URL (e.g., shortened URL), wherein the URL (e.g., shortened URL) serves as a product identifier and/or optionally another product identifier is embedded in the symbology. In response to the decoding of the URL from the captured image of the symbology 20, the mobile device 16 typically automatically accesses the portal apparatus, or more specifically the Product Registration Website provided by the portal apparatus, such as by way of the web browser module, or the like, of the mobile device 16. Reiterating from above, the portal apparatus and its Product Registration and Relationship Websites may be hosted by the server 26, the computer 24, or in any other suitable manner. More specifically and in accordance with the first embodiment, the portal apparatus and its Product Registration and Relationship Websites are hosted by the server 26, and the communication between the mobile device 16 and the portal apparatus is by way of the network 30, wherein the network may comprise the Internet, as discussed above. More specifically, the mobile device 16 may comprise a transceiver module for communicating with one or more cellular data networks, for accessing the Internet.

In response to the mobile device 16 accessing the portal apparatus, or more specifically the Product Registration Website of the portal apparatus, using the symbology 20 for the first time as discussed above, the Product Registration Webpage 21 typically automatically appears on the display screen of the mobile device 16. An example of the Product Registration Webpage 21 is shown in FIG. 3, although the Product Registration Webpage may be in any other suitable configuration. The Product Registration Webpage 21 is configured to be filled with product registration information, and the Product Registration Website is associated with the database 18 for data storage and retrieval. In response to accessing the Product Registration Website and the Product Registration Website receiving the decoded product identifier (e.g., the short URL) as discussed above, the Product Registration Website identifies (e.g., software module(s) associated with the Product Registration Website are executed for identifying) predetermined information in the database 18 (e.g., by way of look-up table(s), or the like) that is associated with the decoded product identifier (e.g., the short URL), for further association with information (i.e., data) input into the Product Registration Webpage 21. This associating together of the information may be achieved through operation of the Product Registration Website (e.g., software module(s) associated with the Product Registration Website).

Through operation of the Product Registration Website (e.g., software module(s) associated with the Product Registration Website), the associated-together information may be stored together in the database 18 as a database registration record, or otherwise linked together and saved in any suitable manner, such as in, or as part of, the computerized look-up table, the CRM computer database, or in any other suitable manner or location. For example, the associated-together information may be referred to as a registration record, and the registration record may be maintained in the database 18 (e.g., the CRM computer database). In summary, the fields of the respective registration record may be automatically populated with the entries in the computerized look-up table that are associated with the decoded product identifier (e.g., the short URL), and the registration record may also be populated with the information input into the Product Registration Webpage 21, e.g., as entered by the recipient 14 via the computerized mobile device 16. These operations may be Lathed out through operation of the Product Registration Website (e.g., software module(s) associated with the Product Registration Website).

The Product Registration Webpage 21 provides for flexible data entry. For example, at least some of the fields of the Product Registration Webpage 21 may be automatically populated with personal information about the recipient 14 that is available from their mobile device 16, if the mobile device has this “auto-fill” feature and it is enabled. These operations may be carried out through cooperative operation of the Product Registration Website (e.g., software module(s) associated with the Product Registration Website) and the mobile device 16 (e.g., software module(s) associated with the mobile device). The recipient 14 may also manually input and/or edit the fields of the Product Registration Webpage 21 (e.g., by way of a keyboard or touchscreen user interface of the mobile device 16).

Stated differently, the Product Registration Website may be optimized specifically for mobile users, so that a simple scan of the symbology 20 by way of a mobile device code reader application executing on the mobile device 16 will auto-generate the model and serial numbers from the computerized look-up tables, or the like, of the computer database 18 using the decoded product identifier (e.g., the short URL). Auto-fill content of a user's mobile device 16 may be accessed, if enabled. More specifically, any personal information already cached on the mobile device 16 (e.g., smart phone) may be automatically uploaded to populate fields of the Product Registration Webpage 21. However, this auto-generation of the personal information would typically have to be enabled by pre-selecting the auto-fill function of the mobile device 16, and typically a user of the Product Registration Webpage 21 will have to affirmatively verify that the data on the Product Registration Webpage is accurate and ready to upload. The Product Registration Website may provide uploaded data from the mobile device 16 and the respective information from the computerized look-up tables, or the like, to the CRM computer database in real-time.

Reiterating, the recipient (e.g., customer or consumer) can scan the symbology 20 associated with their product 10 and automatically be directed to the Product Registration Website, wherein the product identifier (e.g., the short URL) decoded from the symbology is automatically uploaded and used to obtain the model and serial number from the computerized look-up table, or the like. Additional information may also be automatically uploaded to the Product Registration Website, such as name, address, city/state and zip code information from the recipient's mobile device 16, if an “auto-fill” function on the recipient's mobile device (e.g., web browser) is enabled. This automatic uploading of data drastically reduces time and data input errors, while increasing operational efficiency as data feed may be real-time into the CRM system of registration record. Automatically obtaining data in this way also seeks to ensure that the provider (e.g., company) has accurate product tracking information for consumer contact opportunities, not limited to service flashes and potential product recall notifications.

The data for products registered online, as discussed above, may be processed in real-time, and the data may be immediately passed through to the CRM system of registration record. This process caters to recipients (e.g., consumers or customers) by allowing for the usage of current technologies, and it also addresses data collection needs of the provider/company, so that the company may, in turn, better fulfill consumer needs. In one aspect of this disclosure, previously used multiple-step processes and redundant actions are streamlined into a consumer-friendly function that provides more efficient CRM input, yielding greater amounts of analytics data for use in marketing metrics.

In response to the recipient 14 registering their product 10 as discussed above, the Product Registration Website may substantially immediately and automatically confirm the registration to the recipient by way of the recipients mobile devices 16, with the confirmation being in the form of a confirming webpage, e-mail notification, a text message notification, voicemail notification and/or any other suitable confirmation. This confirmation may be characterized, for example, as a following-up with the recipient 14, with this following up comprising using at least some of the personal and product information associated with the registering for communicating with the recipient. Thereafter, the CRM data may be used in a conventional manner or any other suitable manner to communicate with the recipient 14. These communications may be characterized, for example, as a following-up with the recipient 14, with this following up comprising using at least some of the personal and product information associated with the registering for communicating with the recipient.

A second embodiment of this disclosure is like the above-discussed first embodiment, except for variations noted and variations that will be apparent to one of ordinary skill in the art. In accordance with the second embodiment, non-smart phone users are able to use the short URL and/or a concatenated (e.g., shortened) version of the URL by way of a standard web browser or by way of audible (e.g., verbal) communication using a telephone, or the like, as will be discussed in greater detail below.

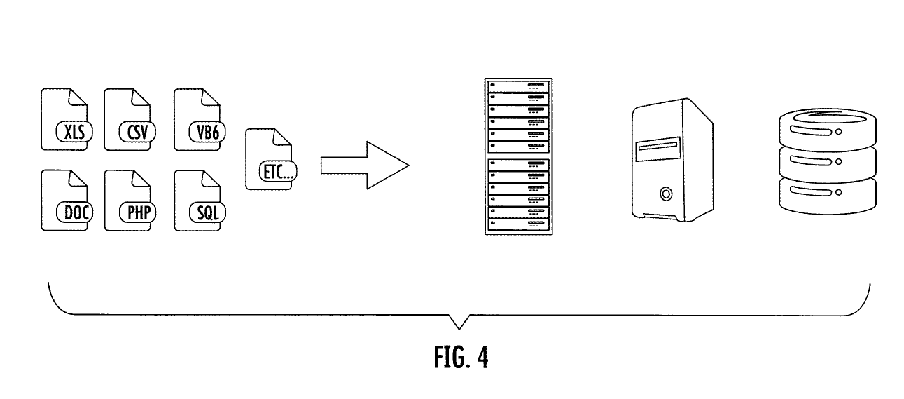

FIGS. 4-7 schematically illustrate aspects of an exemplary method and associated features, in accordance with the first and second embodiments of this disclosure. FIG. 4 schematically illustrates, to the left of the arrow in FIG. 4, that the original format of the base product data (i.e., data about the products 10 (FIG. 1)) may be in any suitable form such as, but not limited to, one or more modules in the form of a spreadsheet, tab-delimited text, comma-separated values or pre-scripted arrays, or any other suitable process-compatible format may be used. The arrow in FIG. 4 schematically illustrates that the base product data (e.g., base product data modules) may be stored on and/or processed by way of one or more of any suitable electronic devices such as, but not limited to, enterprise-level servers (e.g., web or print servers), desktop workstations (e.g., for data scrubbing and/or validation) or other databases. As examples, any sufficient software language may be used, such as Structured Query Language (SQL), and the databases may be managed by any suitable database manager, such as SAP. For example, the base product data (e.g., base product data modules) may be located at one or more of the databases 18, computers 24 or servers 26 of FIG. 1. The base product data may be processed and located in any suitable manner.

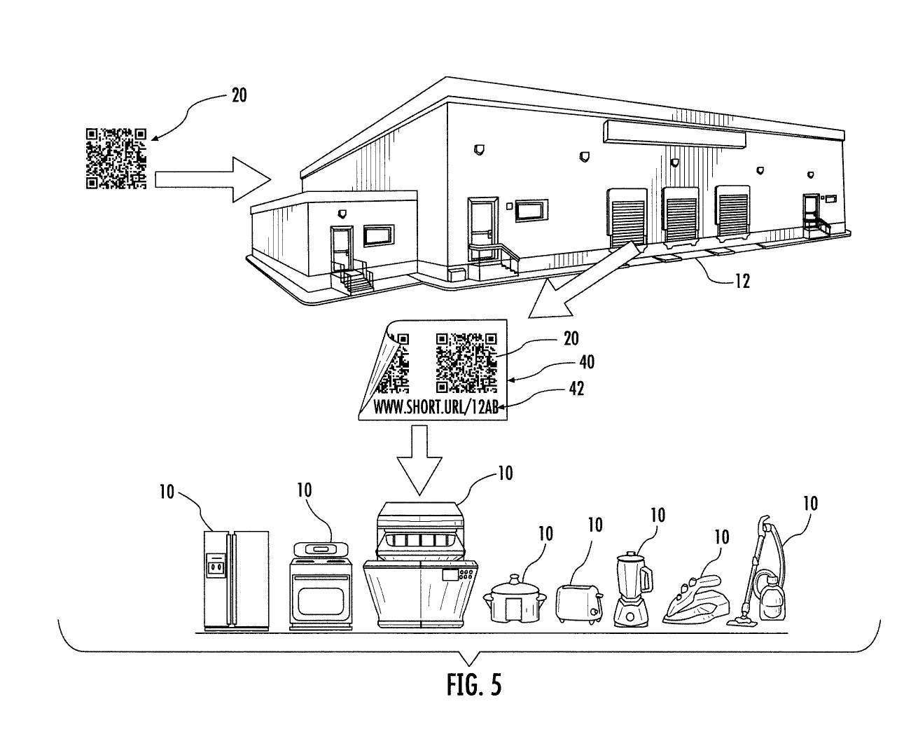

Referring to FIG. 5 and in accordance with the first and second embodiments, the base product data (which may be located at or obtained from, for example, one or more of the electronic devices shown in FIG. 4) is used in the generating of (e.g., via execution of one or more software modules) the symbologies 20 that are to be associated with the products 10 at the facility 12. More specifically, a tagging process (e.g., labeling process) is used for creating tags (e.g., decal or labels 40) that include the symbologies 20. Even more specifically in accordance with the first and second embodiments, scripting (e.g., execution of one or more software modules) at the print server (e.g., the print server for the printer 23 (FIG. 1)) combines product information variables, URL(s), and integrates generation of the symbologies 20 at some point in the labeling process used by the facility 12 (e.g., factory). Scripting at the print server level allows for variable data printing of custom generated symbologies 20 on the product identification labels 40. Also, for each label 40, a text version 42 of the shortened URL contained in the symbology 20 may be printed on the label to accommodate for any accessibility concerns, backwards compatibility and/or manual entry. As at least allude to above, Loftware brand enterprise label and print management software modules may be utilized in creating the labels 40/symbologies 20; however, any other suitable software, firmware and/or hardware may be used. Also, the symbologies 20 and text versions 42 of the shortened URLs contained in the symbologies 20 may be printed on any suitable substrate, such that the present disclosure is not limited to the use of labels 40.

As schematically shown in FIG. 5, the tags/labels 40, which typically comprise both the symbologies 20 and the text versions 42 of the shortened URLs contained in the symbologies, may be mounted to, or otherwise associated with, the products 10 at the facility 12 (e.g., factory). With regard to the assembling and packaging line for the products 10 at the facility 12 (e.g., factory), the labels 40 may be paired with (e.g., mounted to or otherwise associated with) the products 10 at the point where owner's manuals, registration information and product information are paired with the products. In this regard, the labels 40 may have an adhesive backing and may be used in place of, or in addition to, conventional labels (not shown) that are conventionally mounted to, or otherwise associated with, the products at the facility 12. For example, the products 10 may be of any suitable type for which product identification or registration information is provided to the recipient 14 (e.g., consumer) with the product (e.g., appliance).

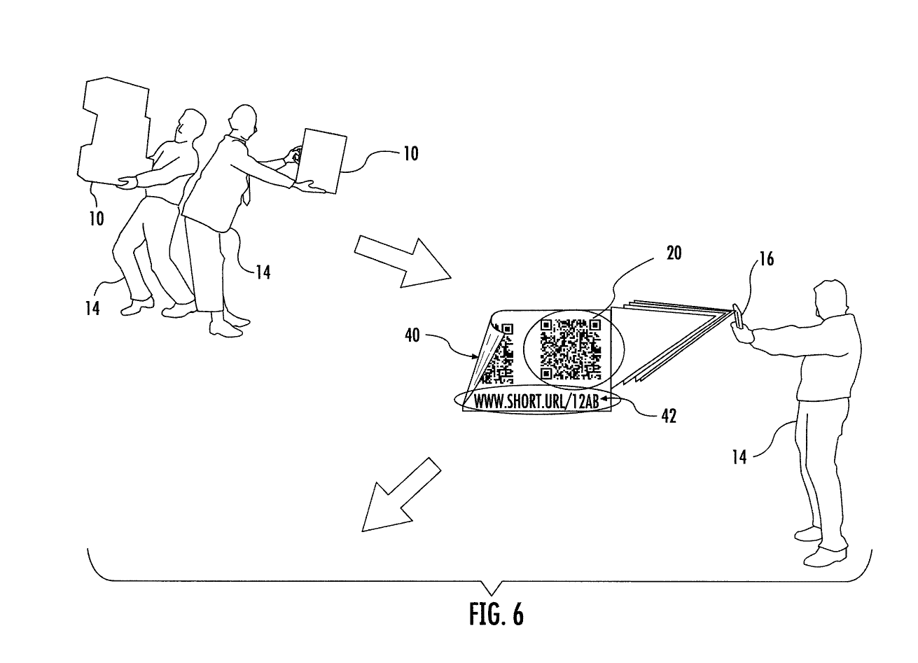

From the facility 12 (e.g., factory), the products 10 may reach the recipients 14 through any suitable conventional channels of distribution, commerce, or the like. For example, FIG. 6 schematically illustrates recipients 14 (e.g., consumers) that are in receipt of (e.g., holding) products 10 that they have, for example, purchased. As should be apparent from the foregoing, the products 10 may be in many different forms and sizes, are not limited to products that may be held by the recipients 14.

When the recipients 14 (e.g., consumers) obtain/receive their products 10, they will have (e.g., at least will be able to readily obtain) access to the labels 40/symbologies 20/text versions 42 of the shortened URLs associated with their products. Preferably (e.g., optionally) and as schematically shown in FIG. 6, the recipient 14 scans the symbology 20 associated with (e.g., mounted to) their product 10 with their computerized mobile device 16 (e.g., smart phone).

Several nonlimiting examples of mobile devices 16 (e.g., smart phones) are shown in FIG. 7. As schematically shown in FIG. 7, the mobile device 16 automatically obtains accesses to the Product Registration Website (e.g., Product Registration Webpage 21) by way of the web browser, or the like, of the mobile device in response to the mobile device scanning the symbology 20 of the label 40 associated with the product. More specifically, scanning the symbology 20 causes the web browser module of the mobile device 16 to be directed to a predetermined website. Through operation of one or more software modules associated with the portal apparatus, a scripted redirection feature of the portal apparatus checks the referring shortened URL, and matches (e.g., via a look-up table of database 18 or any other suitable methods and/or devices) the referring shortened URL to the corresponding long URL so that the Product Registration Webpage 21 of the Product Registration Website is displayed on the display screen of the mobile device 16 as discussed in greater detail below. The URL of the scanned symbology 20 being associated in the database 18 with the information about the product 10 associated with the scanned symbology 20 facilitates the automatic identification of and the automatic populating of at least some of the fields of the Product Registration Webpage 21 displayed on the display screen of the mobile device 16. In addition, other fields of the of the Product Registration Webpage 21 displayed on the display screen of the mobile device 16 may be automatically filled, such as with information (e.g., the recipient's name and address) from the mobile device if the auto-fill function is enabled for the web browser of the mobile device. Accordingly, in one aspect of this disclosure, the portal apparatus is operative for associating the recipient's personal information with information from the provider about the product 10 identified by the product identifier (e.g., the short URL), for product registration purposes, without the recipient inputting at least some of one or more of the information from the provider and the recipient's personal information.

When at least a sufficient number of the fields of the Product Registration Webpage 21 are automatically or otherwise filled, the recipient 14 may visually review and verify the data displayed by way of the Product Registration Webpage and thereafter select a “submit” button or icon on their mobile device 16. Before the submitting, the recipient 14 may edit or otherwise modify the data in one or more of the fields of the Product Registration Webpage 21 using the user interface of their mobile device 16.

As schematically illustrated in FIG. 7, in response to the recipient 14 selecting to submit the data in the fields of the Product Registration Webpage 21, the data in the fields of the Product Registration Webpage 21, and any additional associated data, are transmitted in a predetermined manner for completing the registration process. This completing of the registration process may comprise updating or creating the respective registration record, such as by way of sending the data in the fields of the Product Registration Webpage 21, and any additional associated data, to a local database 32 (e.g., such as the CRM computer database, which may be managed by any suitable database manager, such as SAP). Additionally, the data in the fields of the Product Registration Webpage 21, and any additional associated data, may be sent to a remote databases 34, such as for control and verification, and/or backup purposes. Additionally, a notification 36 may be sent to the recipient 14 to confirm that their registration has been completed and/or for providing any other suitable information (e.g., for soliciting extended service warranty business). As schematically shown in FIG. 7, the notification 36 may be a confirming email (e.g., with the email comprising the data in the fields of the Product Registration Webpage 21, and any other suitable associated data) that may be sent to the recipient 14 (e.g., the recipient's mobile device 16) over the second network 30 to confirm that their registration has been completed. The sending of the data to the databases 32, 34 and the sending of the notification 36 may be facilitated through the execution of one or more software modules associated with the Product Registration Website.

Regarding the local and remote databases 32, 34, the database 18 of FIG. 1 may serve as either one of the local and remote databases 32, 34. Alternatively, one or both of the local and remote databases 32, 34 may be in addition to the database 18, wherein the local and remote databases 32, 34 may be respectively associated with the computer 24 and the server 26, or the databases may be in any other suitable location.

In summary regarding one aspect of this disclosure, if a recipient's mobile device 16 has a web browser module, or the like, with an enabled auto-fill module, and the mobile device is equipped for (e.g., has one or more modules for) scanning and decoding symbologies 20, then the recipient 14 may scan the subject symbology with their mobile device 16 and may substantially immediately thereafter select (i.e., actuate or activate) a “submit” button or icon associated with the Product Registration Webpage 21 to complete their part of the registration process. Accordingly, in one aspect of this disclosure, the portal apparatus is operative for associating the recipient's personal information with information from the provider about the product 10 identified by the product identifier (e.g., the short URL), for product registration purposes, without the recipient inputting at least some of one or more of the information from the provider and the recipient's personal information. For example, the portal apparatus may be operative for associating the recipient's personal information with information from the provider about the product 10 identified by the product identifier (e.g., the short URL), for product registration purposes, without the recipient inputting any of the recipient's personal information into the Product Registration Webpage 21 and/or without the recipient inputting any of the information from the provider about the product 10 into the Product Registration Webpage 21. Alternatively, the recipient 14 may edit or otherwise complete fields of the Product Registration Webpage 21 before selecting the “submit” button or icon associated with the Product Registration Webpage 21.

As an alternative to using a mobile device 16, such as a smart phone, to scan and decode the symbology 20 associated with their product 10, the recipient 14 may utilize the text version 42 of the shortened URL that is typically adjacent to the symbology in order to carry out their part of the registration process. For example, the recipient 14 may manually type the text version 42 of the shortened URL into any suitable computerized device that is executing a web browser software program. Accordingly, the device 16 may be generally characterized as being the suitable computerized device. In response to the recipient 14 manually typing the text version 42 of the shortened URL into the suitable computerized device that is executing the web browser software program, the process may proceed substantially as discussed above. As an alternative to using a computerized mobile device 16 or other suitable computerized device as discussed above, and for maximizing accessibility, a recipient 14 (e.g., perhaps an elderly or disabled consumer) that may not have, may not be able to use, or may not want to use a computerized device, may use a telephone to call a Call Center. For example and during the telephone call, the recipient 14 may read the text version 42 of the shortened URL, which is typically adjacent the symbology 20, to a representative at the Call Center, and the representative at the Call Center may assist in facilitating completion of the registration process.

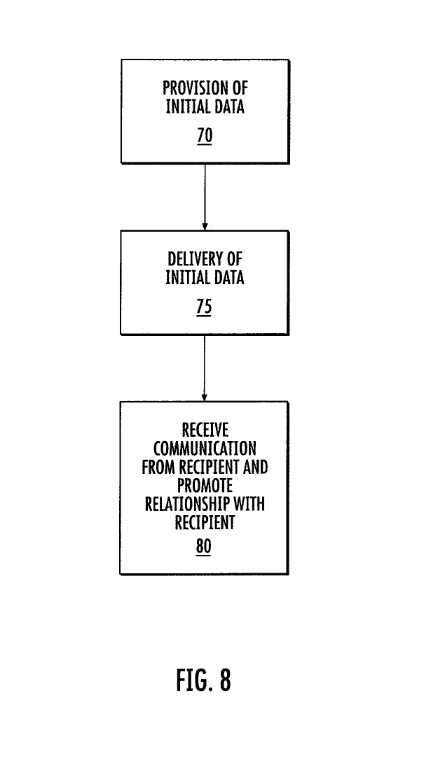

FIG. 8 is a process flow diagram illustrating an exemplary process that may be used for facilitating registration of a product 10 that is provided by a provider and received by a recipient 14, in accordance with an aspect of this disclosure. As shown in FIG. 8, in block 70 initial data is provided. The initial data may include the data discussed above that is in existence prior to the printing of the symbologies 20, such as the data to be embodied in the symbologies and the data in the database 18 prior to the recipients registering their products 10. For example, for each product, the initial data in the database 18 may include only product serial and model numbers, and the unique short URL associated with the product. Also, in the database registration record for each product, the initial data typically further includes a long URL for automatically directing the recipient 14 to the Product Registration Webpage 21 (FIGS. 3 and 7) of the Product Registration Website. That is, the short URLs may be assigned via a lookup table of the database 18 to a long URL for automatically directing the recipients 14 to the Product Registration Webpage 21 of the Product Registration Website. The long URLs may be contained in fields respectively of the registration records in the database 18, so that different short URLs may redirect to different long URLs, and the URLs to which the short URLs redirect may be changed (e.g., over time), as will be discussed in greater detail below.

At least partially reiterating from above, the initial data provided at block 70 may only include the short URL and associated product serial and model numbers, or it may include additional information, such as a long URL associated with the short URL, dates for promotion tracking, boolean assignments for returning users, and/or any other suitable information. In one example, each symbology 20 may include only its short URL, with the information associated with the short URL being associated by way of the look-up table, or the like, of the database 18, or the like. In this example, for each short URL, all information associated with the short URL may be fully variable at any time, by virtue of the information being editable/changeable in the look-up table of the database 18. Alternatively, one or more of the fields of reach registration record in the look-up table of the database 18 may be set up so that its contents may not be edited or otherwise changed.

At block 70, the database 18 may be built out and populated in a manner for facilitating at least the reminder of the registration process. For example, the registration records and fields of the database 18 may be built out, or the like, for being populated with the additional registration information to be provided in the future, and fields may be set up to be dynamically assigned, modified or otherwise adjusted in the future as needed, for handling different languages, returning users, promotional items, surveys or other features for promoting relationships with the recipients 14 (e.g., customers). As indicated above, the database 18 of FIG. 1 may serve as either one of the local and remote databases 32, 34 of FIG. 7. Alternatively, one or both of the local and remote databases 32, 34 may be in addition to the database 18, wherein the local and remote databases 32, 34 may be respectively associated with the computer 24 and the server 26, or the databases may be in any other suitable location. That is, the data of this disclosure may distributed across the databases 18, 32, 34, the multiple databases may be provided for purposes of redundancy (e.g., to increase reliability), and/or the one or more databases may be managed in any other suitable manner.

Continuing with FIG. 8, in block 75, the symbologies 20 may be created and associated with the products 10 as discussed above. Then, in block 80 communications may be received from the recipients 14 as discussed above and as will be discussed in greater detail below, registration of products 10 may be facilitated as discussed above and as will be discussed in greater detail below, and relationships with the recipients 14 may be further facilitated, as discussed above and in greater detail below.

FIG. 9 is a process flow diagram illustrating in greater detail an exemplary processes of block 80 of FIG. 8, in accordance with an aspect of this disclosure. The process illustrated by FIG. 9 may be carried out by the portal apparatus, as will be discussed in greater detail below. Referring to FIG. 9, in block 100, the portal apparatus receives at least the shortened URL, such as from a computerized mobile device 16, or in any other suitable manner, as discussed above.

In some embodiments, processing control is transferred from block 100 to block 105, and in block 105 a determination is made by the portal apparatus as to whether registration has already been completed, such as in the manner described above, for the product identified by the URL. If product registration has not occurred for the URL received at block 100, processing control is transferred to block 110. If product registration has already occurred for the URL received at block 100, processing control is transferred to block 120. In block 110, the portal apparatus sends the Product Registration Webpage 21 (FIGS. 3 and 7) of the Product Registration Website to the computerized device 16 from which the short URL was received at block 100. In contrast, in block 120, the portal apparatus sends the Relationship Webpage (FIG. 10) of the Relationship Website to the computerized device 16 from which the short URL was received at block 100.

In some embodiments, it may be preferable (e.g., optional) for decision block 105 to be generally or substantially omitted and/or for its functionality to be provided in another suitable way. For example, prior to block 100, such as in block 70 of the process of FIG. 8, the long URL for the Product Registration Webpage 20 may be associated, in the database 18, with the short URL to be received at block 100. As a result and for example, in response to the mobile device 16 sending a short URL to the portal apparatus for the first time, or perhaps any other time before product registration is completed for the product associated with the short URL, the portal apparatus may automatically, responsively transfer processing control from block 100 to block 110, so that the portal apparatus sends the Product Registration Webpage 21 of the Product Registration Website to the computerized device 16 from which the short URL was received at block 100.

On the other hand and as will be discussed in greater detail below, after the product registration has been completed for the product associated with the short URL received at block 100, the long URL for the Relationship Webpage (FIG. 10) of the Relationship Website will have already been associated in the database 18 with the short URL received at block 100, so that the portal apparatus may automatically, responsively transfer processing control from block 100 to block 120, so that the portal apparatus sends the Relationship Webpage of the Relationship Website to the computerized device 16 from which the short URL was received at block 100.

Processing control is transferred from block 110 to block 125. At block 125, the registration may be completed for the product 10 associated with the URL received at block 100, and the registration may be completed through the use of the Registration Webpage 21 of the Product Registration Website, as discussed in detail above.

Processing control is transferred from block 130 to block 135. At block 135, the portal apparatus queries the database 18 to determine whether the recipient 14 associated with the URL received at block 100 has a relationship account number, or the like, for allowing the recipient to access the Relationship Webpage of the Relationship Website. If a negative determination is made at block 135, processing control is transferred to block 140. If a positive determination is made at block 135, processing control is transferred tc block 145.

In block 140, the first time a recipient 14 registers a product 10 using the portal apparatus as discussed above, the recipient is assigned a unique, relationship account number for use with the portal apparatus (e.g., the Relationship Website), and that unique relationship account number is associated with the recipient in the database 18. In block 145, each time a recipient 14 with a relationship account number registers a product 10 using the portal apparatus, their relationship account number is associated with the product associated with the short URL received any at block 100. Processing control is transferred from block 145 to block 150, although the operations of block 150 may occur at any suitable time that may be simultaneous with or after the operations of block 130.

At block 150, in the database 18, or more specifically in the registration record associated with the short URL received at block 100, the field containing the long URL for the Registration Webpage of the Registration Website is edited so that field contains the long URL for the Relationship Webpage of the Relationship Website rather than long URL for the Registration Webpage of the Registration Website. Alternatively, other suitable measures may be taken at block 150 so that, going forward, when the short URL associated with an already registered product 10 is received at block 100, the short URL redirects to the URL for the Relationship Webpage of the Relationship Website (e.g., processing control is transferred from block 100 to block 120). Processing control is transferred from block 145 or 150 to block 155.

In block 155, the portal apparatus (e.g., the Product Registration Website) may substantially immediately and automatically confirm the registration to the recipient by way of the recipients mobile devices 16, with the confirmation being in the form of a confirming webpage, e-mail notification, a text message notification, voicemail notification and/or any other suitable confirmation. Alternatively or in addition, registration confirmation may be provided or further provided by processing control being transferred to block 120. As indicated above, in block 120, the portal apparatus sends the Relationship Webpage (FIG. 10) of the Relationship Website to the computerized device 16 from which the short URL was received at block 100, or to another suitable location.

An example of a Relationship Webpage of the Relationship Website is shown in FIG. 10, although the Relationship Webpage and Website may be in any other suitable configuration. In accordance with one aspect of this disclosure, when the Relationship Webpage or Website is provided in block 120, the Relationship Webpage or Website is automatically customized in view of the relationship account associated with the short URL that was received at block 100. That is and in certain embodiments, the Relationship Webpage or Website is automatically customized taking into account at least some of, or substantially all of, the products 14 and other relevant information that is included in the database 18 and is associated with the relationship account associated with short URL that was received at block 100.

In certain embodiments of this disclosure, the portal apparatus is operative for facilitating intentional involvement of a provider (e.g., company) in its engagement with recipients 14 (e.g., consumers, such as customers) over an extended period of time, such as for promoting an exchange of communications through the Relationship Website, wherein the communications via the Relationship Website may include promotions of future purchases, cross-sell offers, targeted ads, maintenance reminders, and other suitable features for facilitating consumer engagement with the provider. That is, the Relationship Website may be operative to encourage the consumer to provide additional data to the provider (e.g., company), which the provider may use for a variety of purposes. For example, one aspect of this disclosure is the provision of a system that seeks to promote product registration and serve as an enhanced customer relationship management system. The system of this disclosure may advantageously be used to promote standardization of product labeling and registration procedures.

Referring for example to the Relationship Webpage shown in FIG. 10, it includes icons for numerous pull-down or fold-out menu(s), such as for subscriptions, appliances and accessories, and each of the menus may cascade hierarchally. For example, FIG. 10 schematically shows a subscriptions menu or tab folded out, or the like, so as to provide selectable icons for “water filters”, “cleaners” and “maintain parts”. Similarly, other menus, tabs and/or icons of the Relationship Website may be selected, folded out, or the like. A variety of icons, menus, tabs and other graphic user interface features are within the scope of this disclosure.

In addition or alternatively, each recipient 14 having a relationship account with the portal apparatus may be able to interact with the portal apparatus to implement their preferences and have those preferences stored in the database 18, or the like, and reflected in their personalized Relationship Webpage. For example, a registered recipient 14 may choose to have information about their registered products 10 organized and displayed all together in their personalized Relationship Webpage, such as by having their registered products sorted or organized as major appliances, small appliances, accessories, or the like. The sorting/organizing may also be by product line, like Cooking/Kitchen, Laundry, etc. In addition to the Relationship Website presenting information from the database 18, it may also present advertising and other types of offers to the recipients 14, for example as shown in FIG. 10.

In the foregoing, each server, computer or computerized device may be in the form of, or comprise, one or more computer or computer-like devices (which may include one or more appropriate input and output devices, processors, memories and software module(s) (e.g., computer-readable mediums having computer-executable instructions for performing one or more of the steps described herein)). Similarly, each computerized look-up table, computer database or software module may be in the form of one or more computerized look-up tables, computer databases or software module(s), and vice versa.

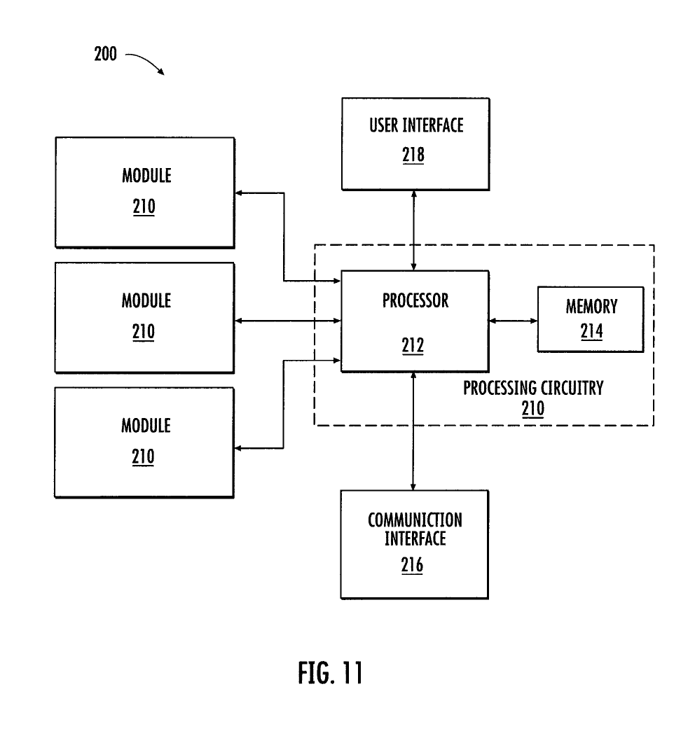

As a more specific example, FIG. 11 illustrates a block diagram of an apparatus 200 that is representative of apparatuses that may be respectively implemented on each of the above-discussed servers, computers or computerized devices (e.g., the mobile device 16, computer 24 and server 26), in accordance with some exemplary embodiments of this disclosure. It will be appreciated that the components, devices or elements illustrated in and described with respect to FIG. 11 below may not be mandatory and thus some may be omitted in certain embodiments. Additionally, some embodiments may include further or different components, devices or elements beyond those illustrated in and described with respect to FIG. 11.

In some exemplary embodiments, the apparatus 200 may include processing circuitry 210 that is configurable to perform actions in accordance with one or more exemplary embodiments disclosed herein. In this regard and for the apparatus 200 implemented on the mobile device 16, the processing circuitry 210 may be configured to perform and/or control performance of one or more of the above-discussed functionalities of the mobile device 16 in accordance with various exemplary embodiments. Similarly, for the apparatus 200 implemented on the computer 24, the processing circuitry 210 may be configured to perform and/or control performance of one or more of the above-discussed functionalities of the computer 24 in accordance with various exemplary embodiments. As another example, for the apparatus 200 implemented on the server 26, the processing circuitry 210 may be configured to perform and/or control performance of one or more of the above-discussed functionalities of the server 26 in accordance with various exemplary embodiments.

In some exemplary embodiments, the processing circuitry 210 may include a processor 212 and, in some embodiments, such as that illustrated in FIG. 11, may further include memory 214. The processing circuitry 210 may be in communication with or otherwise control a communication interface 216, user interface 218, and one or more modules 220 such as, but not limited to, respective ones of the above-discussed modules. That is, the modules 220 may be respectively illustrative of the above-discussed modules of the mobile device 16, computer 24 and server 26.

The processor 212 may be embodied in a variety of forms. For example, the processor 212 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 212 may comprise a plurality of processors. The plurality of processors may be in operative communication with each other and may be collectively configured to perform one or more of the above-discussed functionalities. In some exemplary embodiments, the processor 212 may be configured to execute instructions that may be stored in the memory 214 or that may be otherwise accessible to the processor 212. As such, whether configured by hardware or by a combination of hardware and software, the processor 212 is capable of performing operations according to various embodiments while configured accordingly.

In some exemplary embodiments, the memory 214 may include one or more memory devices. Memory 214 may include fixed and/or removable memory devices. In some embodiments, the memory 214 may provide a non-transitory computer-readable storage medium that may store computer program instructions that may be executed by the processor 212. In this regard, the memory 214 may be configured to store information, data, applications, instructions and/or the like for enabling the electronic communications device 102 to carry out various functions in accordance with one or more exemplary embodiments. In some embodiments, the memory 214 may be in communication with one or more of the processor 212, communication interface 216, user interface 218, and modules 220 via bus(es) for passing information among components of the apparatus 200.

As alluded to above, the apparatus 200 may include a communication interface 216. The communication interface 216 may be configured to enable the device (e.g., the mobile device 16, computer 24 and server 26) on which the apparatus is implemented to communicate with one or move other computing devices. In this regard, the communication interface 216 may include one or more interface mechanisms for enabling communication with other devices and/or networks. As such, the communication interface 216 may include, for example, an antenna (or multiple antennas) and supporting hardware and/or software for enabling communications with a wireless communication network (e.g., a cellular network, WLAN, and/or the like) and/or a communication modem or other hardware/software for supporting communication via cable, digital subscriber line (DSL), USB, FireWire, Ethernet or other wireline networking methods. As such, the communication interface 216 of some exemplary embodiments may be configured to support communications over the network(s) 28, 30.

As alluded to above, the apparatus 200 may include a user interface 218. The user interface 218 may be in communication with the processing circuitry 210 to receive an indication of a user input at the user interface 218 and/or to provide an audible, visual, mechanical or other output to the user. As such, the user interface 218 may include, for example, a keyboard, a mouse, a joystick, a display, a touch screen, a microphone, a speaker, and/or other input/output mechanisms.

In accordance with certain exemplary embodiments of this disclosure, the apparatus 200 is or otherwise comprises the above-discussed portal apparatus, such that reference numeral 200 designates the portal apparatus. In accordance with these exemplary embodiments, one of the modules 210 of the portal apparatus 200 may configured for providing the Registration Website, and another of the modules 210 of the portal apparatus 200 may configured for providing the Relationship Website, such that reference numerals 210 designate Registration and Relationship Website modules. Notwithstanding, the Registration and Relationship Websites may be provided together as a module or may be provided by a series modules and/or portal apparatuses, or in any other suitable manner.

One aspect of this disclosure is the provision of the portal apparatus 200, wherein the portal apparatus provides features for promoting communications between the provider and the recipient, and at least some of these communications promote the marketing-related interests of the provider. In addition or alternatively, the communications may be for providing data to be analyzed by the provider in a manner that is less marketing focused. As one specific example, the Relationship Website and/or one or more other features of this disclosure may be omitted or varied for a wide variety of purposes.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A method for at least registering a product that is provided by a provider and received by a recipient, the method comprising:
associating at least one symbology with the product, wherein the at least one symbology comprises a decodable URL for at least indirectly accessing a website comprising a webpage, the at least one symbology is configured to be imaged and decoded at least by a mobile device associated with the recipient, and associated with the URL is at least one product identifier of a plurality of different product identifiers;
associating the product identifier with information from the provider about the product in at least one computer database, wherein at least some of the information about the product varies between products;
receiving the URL from a web browser of a recipient's mobile device;
sending the webpage to the web browser of the recipient's mobile device at least in response to receiving the URL from the web browser of the recipient's mobile device, wherein the webpage includes fields for receiving personal information from the recipient for registering the product identified by the product identifier;
receiving the recipient's personal information from the web browser of the recipient's mobile device, at least partially in response to sending the webpage; and
associating the recipient's personal information with the information from the provider about the product identified by the product identifier, for product registration purposes.

2. The method according to claim 1, further comprising following up with the recipient, comprising using at least some of the associated personal and product information for communicating with the recipient.

3. The method according to claim 1, wherein the symbology comprises a two-dimensional matrix code symbology.

4. The method according to claim 1, wherein the information from the provider about the product comprises a serial number for the product.

5. The method according to claim 1, wherein the information from the provider about the product comprises a model number for the product.

6. The method according to claim 1, wherein the recipient's personal information comprises an address for communicating with the recipient.

7. A method for at least registering a product that is provided by a provider and received by a recipient, wherein at least one symbology is associated with the product, the symbology comprises a decodable URL for at least indirectly accessing a website comprising a webpage, the at least one symbology is configured to be imaged and decoded, and associated with the URL is at least one product identifier of a plurality of different product identifiers, and wherein the method comprises:
receiving the URL;
sending the webpage to a web browser of a device associated with the recipient at least in response to receiving the URL, wherein the webpage includes fields for receiving personal information from the recipient for registering the product identified by the product identifier;
receiving the recipient's personal information from the web browser of the device associated with the recipient, at least partially in response to sending the webpage; and
associating the recipient's personal information with the information from the provider about the product identified by the product identifier, for product registration purposes.

8. The method according to claim 7, wherein the method occurs without the recipient inputting at least some of one or more of the information from the provider and the recipient's personal information.

9. The method according to claim 7, wherein the method is a computer implemented method.

10. The method according to claim 7, wherein receiving the URL comprises receiving the URL from the web browser of the device associated with the recipient.

11. The method according to claim 7, further comprising at least indirectly determining that the product has not been previously registered, wherein:
the webpage is a registration webpage; and
sending the registration webpage is responsive to the determining that the product has not been previously registered.

12. The method according to claim 7, wherein the webpage is a first webpage, and the method further comprises;
another occurrence of receiving the URL; and
sending a second webpage to the web browser of the device associated with the recipient in response to the another occurrence of receiving the URL.

13. The method according to claim 12, wherein the first webpage is a registration webpage, and the second webpage is a relationship webpage.

14. An apparatus for at least registering a product that is provided by a provider and received by a recipient, the apparatus comprising processing circuitry configured to control the apparatus to at least:
receive a URL, wherein associated with the URL is at least one product identifier of a plurality of different product identifiers;
send a webpage to a web browser of a device associated with the recipient at least in response to the receiving of the URL, wherein the webpage includes fields for receiving personal information about the recipient for registering the product identified by the product identifier;
receive the recipient's personal information from the web browser of the device associated with the recipient, at least partially in response to the sending of the webpage; and
associate the recipient's personal information with information from the provider about the product identified by the product identifier, for product registration purposes, without the recipient inputting at least some of one or more of the information from the provider and the recipient's personal information.

15. A computer program product for at least registering a product that is provided by a provider and received by a recipient, the computer program product comprising at least one non-transitory computer readable storage medium having computer program instructions stored thereon, the computer program instructions comprising program instructions, which when performed by a processor, are configured to cause the processor to control an apparatus to at least:
receive a URL, wherein associated with the URL is at least one product identifier of a plurality of different product identifiers;
send a webpage to a web browser of a device associated with the recipient at least in response to the receiving of the URL, wherein the webpage includes fields for receiving personal information from the recipient for registering the product identified by the product identifier;
receive the recipient's personal information from the web browser of the device associated with the recipient, at least partially in response to the sending of the webpage; and
associate the recipient's personal information with information from the provider about the product identified by the product identifier, for product registration purposes, without the recipient inputting at least some of one or more of the information from the provider and the recipient's personal information.
